(19) United States
(12) Patent Application Publication
(10) Pub. No.: US 2025/0296613 A1
(43) Pub. Date: Sep. 25, 2025

(54) UTILITY CART SYSTEM

(71) Applicant: OLYMPIA TOOLS INTERNATIONAL, INC., Covina, CA (US)

(72) Inventors: John Griffin BIERING, JR., Huntersville, NC (US); Nicholas IMSAND, Huntersville, NC (US); Cecil WILSON, Sanford, NC (US)

(21) Appl. No.: 19/075,048

(22) Filed: Mar. 10, 2025

Related U.S. Application Data
(60) Provisional application No. 63/568,987, filed on Mar. 22, 2024.

(51) Int. Cl. B62B 3/02; B62B 3/04; B62B 3/10

(52) U.S. Cl. CPC B62B 3/02; B62B 3/04; B62B 3/10; B62B 2205/006

(57) ABSTRACT

A utility cart system including a top shelf with a recessed tray and a bottom shelf disposed below the top shelf. A plurality of shelf supports are used to couple the top shelf to the bottom shelf. A plurality of casters are coupled to a bottom of the bottom shelf. A modular shelf is movable between a first position and a second position. In the first position, the modular shelf is disposed between the top shelf and the bottom shelf and coupled to the plurality of shelf supports. In the second position, the modular shelf is at least partially disposed in the recessed tray of the top shelf.

### CROSS-REFERENCE TO RELATED APPLICATIONS

This application claims the benefit of U.S. Provisional Application 63/568,987 filed on Mar. 22, 2024, which application is herein incorporated by reference in its entirety.

### BACKGROUND

### Field

Aspects of the present disclosure generally relate to a utility cart system.

### Description of the Related Art

Embodiments herein generally relate to a utility cart system, more particularly, embodiments relating to a utility cart system with a plurality of shelves and features. Although there are many different types of utility cart systems, there is a need for an improved utility cart system.

### SUMMARY

A utility cart system, including a top shelf with a recessed tray, a bottom shelf disposed below the top shelf, a plurality of shelf supports coupling the top shelf to the bottom shelf, a plurality of casters coupled to a bottom of the bottom shelf, and a modular shelf movable between a first position and a second position. In the first position, the modular shelf is disposed between the top shelf and the bottom shelf and coupled to the plurality of shelf supports and in the second position, the modular shelf is at least partially disposed in the recessed tray of the top shelf.

A utility cart system, including a top shelf with a recessed tray, wherein the recessed tray comprises a shoulder above a bottom of the recessed tray, a bottom shelf disposed below the top shelf and coupled to the top shelf by a plurality of legs, a plurality of casters coupled to a bottom of the bottom shelf and coupled to the plurality of legs, wherein each leg of the plurality of legs is coupled to each caster of the plurality of casters by a fastener passing through the bottom shelf, and a modular shelf having a size that is at least partially disposable in the recessed tray and a connector for coupling with the plurality of legs.

A utility cart system, including a top shelf with a recessed tray, wherein the recessed tray includes a shoulder above a bottom of the recessed tray, a bottom shelf disposed below the top shelf, a plurality of casters coupled to the bottom shelf, and a modular shelf disposable between a first position and a second position. In the first position, the modular shelf is disposed between the top shelf and the bottom shelf on a plurality of shelf supports, wherein each shelf support of the plurality of shelf supports comprise a support surface and in the second position, the modular shelf is disposed on the shoulder of the top shelf and the modular shelf encloses the recessed tray.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a top perspective view of a utility cart system with a modular shelf in a first position, according to an exemplary embodiment of the present disclosure;

FIG. 1B is a top perspective view of the utility cart system with a modular shelf of FIG. 1A in a second position;

FIG. 2 a top perspective view of the modular shelf of FIG. 1;

FIG. 3 is a cross-sectional view of the utility cart system with the modular shelf in the first position of FIG. 1A;

FIG. 4A is a detail view of a shelf support of the utility cart system in the first position as indicated in FIG. 1A;

FIG. 4B is a detail view of the shelf support of the utility cart system in the second position as indicated in FIG. 1B;

FIG. 5 is a top perspective view of a bottom shelf of the utility cart system of FIG. 1; and

FIG. 6 is a detail view of a cross-sectional view of the bottom shelf of the utility cart system of FIG. 1.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The disclosure contemplates that terms such as “couples,” “coupling,” “couple,” and “coupled” may include but are not limited to welding, interference fitting, and/or fastening such as by using bolts, threaded connections, pins, clips, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links.

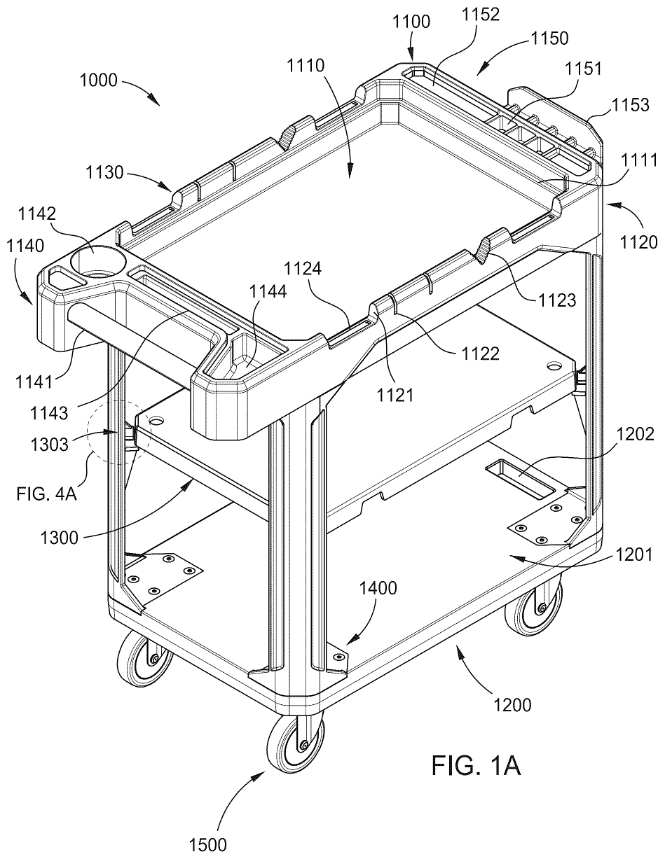

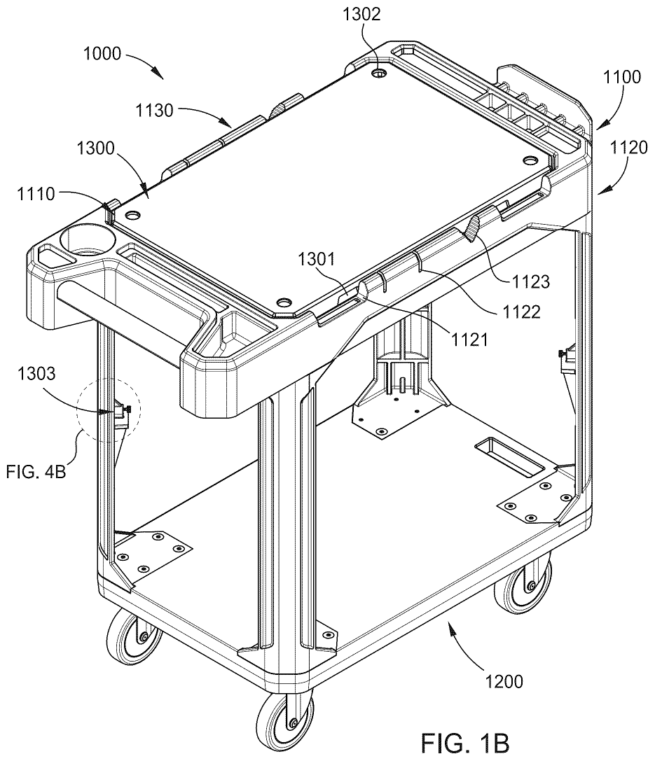

FIGS. 1-6 illustrate a utility cart system 1000, according to one embodiment.

FIG. 1A illustrate a top perspective view of the utility cart system 1000. The utility cart system 1000 includes a top shelf 1100, a bottom shelf 1200, a modular shelf 1300, a plurality of legs 1400, and a plurality of casters 1500. In the first position, as shown in FIG. 1A, the modular shelf 1300 is assembled between the top shelf 1100 and the bottom shelf 1200. In some embodiments, such as the one shown in FIG. 1A, the modular shelf is assembled in the middle of the top shelf 1100 and the bottom shelf 1200. In one or more embodiments, the modular shelf 1300 is assembled closer to the top shelf 1100 or the bottom shelf 1200.

In the first position, the top shelf 1100 is disposed above the modular shelf 1300, which is disposed above the bottom shelf 1200. The shelves 1100, 1200, and 1300 are supported and coupled to one another by the plurality of legs 1400. The utility cart system 1000 is movable by the plurality of casters 1500 coupled to the bottom shelf 1200. The plurality of casters 1500 may be attached to the bottom shelf 1200 or the plurality of legs 1400.

The top shelf 1100 includes a tray 1110, a first side rail 1120, a second side rail 1130, a rear portion 1140, and a front portion 1150. The tray 1110 is a recessed portion in the top shelf 1100. The tray 1110 is shaped to contain various objects, thereby preventing said objects from escaping the top shelf 1100. The tray 1110 is generally rectangular as illustrated, but may be any desired shape. In some examples, the tray 1110 also includes chamfered corners. In this example, the tray 1110 includes a shoulder 1111 that circumscribes the tray 1110. The shoulder 1111 is located between the bottom portion of the tray 1110 and the top of the first side rail 1120, the second side rail 1130, the top of the rear portion 1140, and the top of the front portion 1150 and allows for flat components to rest upon the shoulder 1111. As will be discussed in the description of FIG. 1B, the modular shelf 1300 may rest on the shoulder 1111 to act as a lid to the tray 1110 and to act as a flat work surface on the top shelf 1100.

The first side rail 1120 and the second side rail 1130 are disposed on either side of the top shelf 1100. In one or more embodiments, such as the one illustrated, the first side rail 1120 and the second side rail 1130 are mirror images of each other.

The side rails 1120, 1130 include a rectangular cut-out 1121 shaped to hold lengths of raw materials across the top shelf 1100. In the presently illustrated embodiment, the rectangular cut-out 1121 is shaped to hold a length of 2×4 and is thus dimensioned 1.5″ by 3.5.″ In one or more embodiments, the rectangular cut-out 1121 may be shaped to hold a length of other standard wood dimensions, standard angle iron dimensions, and/or may be dimensioned generally to hold lengths of differently shaped and sized raw materials. The rectangular cut-out 1121 is configured to hold lengths of raw materials for transport and for other purposes, such as cutting and/or shaping. The dimensions of the rectangular cut-out 1121 are only constrained by the depth of the top shelf 1100, the length of the side rails 1120, 1130, and the shape and size of the other components of the top shelf 1100. As shown, the first side rail 1120 and the second side rail 1130 have rectangular cut-outs 1121 at the same axial position as one another so as to allow lengths of raw materials longer than the width of the top shelf 1100 to be contained by the rectangular cut-outs 1121.

The bottom portion of the rectangular cut-out 1121 may also include a slot 1124. The slot 1124 may or may not completely pass through the entirety of the side rail 1120, 1130. The slot 1124 may be shaped to allow for fasteners, protrusions, or tools to pass through and may include threaded portions and/or nuts for to retain the fasteners.

The side rails 1120, 1130 further include at least two handle slots 1122. The handle slots 1122 are shaped and spaced so that handles of tool bags (not pictured) may be slid into the slots 1122 so as to hang the tool bag off of the side of the side rails 1120, 1130. The slots 1122 are dimensioned so that the loop of the tool bag handles may be slid into the slots 1122. The slots 1122 are cut from the top of the side rails 1120, 1130 and are cut a desired length down each of the side rails 1120, 1130 toward the bottom of the tray 1110. The dimensions of the slots 1122 are only constrained by the depth of the top shelf 1100, the length of the side rails 1120, 1130, and the shape and size of the other components of the top shelf 1100.

The side rails 1120, 1130 further include a pipe cut-out 1123. The pipe cut-out 1123 is V-shaped and can include gripping elements, such as teeth, in the interior of the V-shape. The pipe cut-out 1123 is shaped to hold lengths of cylindrically-shaped raw materials, such as pipe. The pipe cut-out 1123 is V-shaped to prevent cylindrically-shaped raw materials from rolling or otherwise moving. The pipe cut-out 1123 includes gripping elements to prevent the cylindrically-shaped raw materials from spinning freely in the pipe cut-out 1123. The pipe cut-out 1123 is configured to hold lengths of cylindrically-shaped raw materials for transport and for other purposes, such as cutting and/or shaping. As shown, the first side rail 1120 and the second side rail 1130 have pipe cut-outs 1123 at the same axial position as one another so as to allow lengths of cylindrically-shaped raw materials longer than the width of the top shelf 1100 to be contained by the pipe cut-outs 1123.

In some embodiments, the first side rail 1120 and the second side rail 1130 include different features (such as rectangular cut-out 1121, slots 1122, and pipe cut-out 1123) from one another. In some embodiments, the side rails 1120 and 1130 include different orientations and different numbers of features as those illustrated in FIG. 1A. It is contemplated inclusion of one or more of the cut-outs and slots 1121, 1122, 1123 is optional. In some embodiments, the side rails 1120, 1130 do not include any cut-outs or slots.

The rear portion 1140 of the top shelf 1100 protrudes beyond the tray 1111 and acts as a third rail for the tray 1111. The rear portion 1140 includes a handle 1141, a cup holder 1142, a device holder 1143, and one or more recesses 1145. The handle 1141 protrudes from the rear of the utility cart system 1000. The handle 1141 allows users to push and steer the utility cart system 1000. In one or more embodiments, the handle 1141 may protrude from any side of the utility cart system 1000 at varying heights so as to allow a user to push and steer the utility cart system 1000. The cup holder 1142 is a cylindrically shaped recess in the top shelf 1100 shaped to allow for cups to be held in place on the top shelf 1100 without tipping over or otherwise moving around. The device holder 1143 is a slot shaped recess that extends laterally along the rear portion 1140 of the top shelf 1100. The device holder 1143 is dimensioned so that a device, such as a phone or tablet, may be propped upright for hands-free use. The plurality of recesses 1145 are disposed around the rear portion 1140 of the top shelf 1100 and are variably shaped and dimensioned for holding objects. The plurality of recesses 1145 may also have varying depths. The dimensions of the plurality of recesses 1145 are constrained only by the dimensions of the other features of the top shelf 1100 and the top shelf 1100 itself.

The front portion 1150 of the top shelf 1100 protrudes beyond the tray 1111 and acts as a fourth rail of the trail 1111. The front portion 1150 includes a vertical material holder 1151, one or more recesses 1152, and an accessory hook 1153.

The vertical material holder 1151 includes holes that pass through the top shelf 1100. In the presently illustrated embodiment, there are three square holes adjacent to one another that pass through the top shelf 1100. The vertical material holder 1151 permit lengths of material to be passed through the holes and stored vertically on the utility cart system 1000 for transport. As will be discussed later, the lengths of material stored in the vertical material holder 1151 rest and are retained in the material holder recess 1202 of the bottom shelf 1200. The vertical material holder 1151 may be shaped to hold a length of standard wood dimensions, standard angle iron dimensions, standard pipe dimensions, and/or may be dimensioned generally to hold lengths of differently shaped raw materials. The dimensions of the vertical material holder 1151 are only constrained by the depth of the top shelf 1100, the length and width of the front portion 1150 of the top shelf 1100, and the shape and size of the other components of the top shelf 1100.

The one or more recesses 1152 are disposed on and around the front portion 1150 and are variably shaped and dimensioned for holding various objects. The one or more recesses 1152 may also have varying depths. The dimensions of the one or more recesses 1152 are constrained only by the dimensions of the other features of the top shelf 1100 and the top shelf 1100 itself.

The accessory hook 1153 protrudes from the front of the front portion 1150 of the top shelf 1100. In one or more embodiments, the accessory hook 1153 may protrude from any side of the utility cart system 1000 at varying heights to allow for objects to be hung from the accessory hook 1153. The hook 1153 includes an axial protrusion with a vertical protrusion at the end of the axial protrusion. Thus, the hook 1153 may have a front facing surface, a bottom surface, and a rear facing surface so that the surfaces are generally in a U-shape. The hook 1153 also includes axial structural supports along the axial protrusion to support the weight of objects hung on the axial protrusion. The hook 1153 is shaped so that a ladder and/or step-ladder (not pictured) may be hung on the hook by one of the ladder's rungs. Thus, said ladder can be transported vertically on the utility cart system 1000. Although the accessory hook 1153 has been described above as holding a ladder and/or step-ladder, the accessory hook 1153 may hold anything that may need to be hung from the utility cart system 1000 including, but not limited to, a wound extension cord, cables, hoses, raw materials, clamps, and bags.

It contemplated the one or more of the handle 1141, the cup holder 1142, the device holder 1143, one or more recesses 1145, the vertical material holder 1151, one or more recesses 1152, and the accessory hook 1153 are optional.

The modular shelf 1300 can be located at different positions on the utility cart system 1000. In the first position as shown in FIG. 1A, the modular shelf 1300 is assembled between the top shelf 1100 and the bottom shelf 1200 and coupled to the legs 1400. In the first position, the modular shelf 1300 is assembled to the utility cart system 1000 through shelf supports 1303 disposed on at least three of the legs 1400. In the presently illustrated embodiment, the shelf supports 1303 are disposed in the middle of the legs 1400 at a height between the top shelf 1100 and the bottom shelf 1200, however, in some embodiments, there may be multiple shelf supports 1303 per leg 1400 with varying heights so that the modular shelf 1300 has an adjustable height.

The bottom shelf 1200 is disposed below the top shelf 1100 and the modular shelf 1300 and is assembled to the top shelf 1100 by the legs 1400. The legs 1400 are assembled into and coupled to the corners of the bottom shelf 1200 by, for instance, fasteners. The bottom shelf 1200 is generally rectangular and has a flat surface 1201 for storing objects atop. The bottom shelf 1200 may have rounded or chamfered corners.

The casters 1500 are assembled and coupled to the bottom of the bottom shelf 1200. In some embodiments, the casters 1500 may swivel about the vertical axis to allow for turning and positioning of the cart. In some embodiments, the casters 1500 may not swivel. Still, in other embodiments, the casters 1500 may be lockable with respect to swivelling and/or rolling. In some embodiments, the casters 1500 may be a combination of any of the above described casters 1500 with a combination of any of the above features.

FIG. 1B is a top perspective view of utility cart system 1000 with the modular shelf 1300 in a second position. In the second position, the modular shelf 1300 is removed from the shelf supports 1303 on the legs 1400 and is disposed in the tray 1110 of the top shelf 1100. In this example, the modular shelf 130 also function as a lid for the tray. As such, the modular shelf 1300 is shaped complementary to the tray 1110 of the top shelf. That is, it is generally rectangular and may have chamfered or rounded corners to match the circumferential shape of the tray 1110. The modular shelf 1300 covers the top of the tray 1110 to restrict access to the tray 1110. In the second position, the modular shelf 1300 rests on the shoulder 1111 of the tray to keep the modular shelf 1300 raised above the bottom of the tray 1110 creating a space for objects to be stored in the now enclosed tray 1110. In the second position, the modular shelf 1300 may create a flat surface across the top shelf 1100 and may act as a work-surface. In some embodiments, such as the one illustrated in FIG. 1B, the modular shelf 1300 is substantially flush with the top of the side rails 1120, 1130. Whereas, In some embodiments, the top surface of the modular shelf 1300 is disposed above the side rails 1120, 1130 or below the side rails 1120, 1130. In some embodiments, the modular shelf 1300 rests on the top surface of the tray 1110.

Removal of the modular shelf 1300 from the second position may be accomplished through the use of finger holes 1302 disposed on and/or through the top of the modular shelf 1300. The modular shelf 1300 may also be removed through use of the side access ports 1301. Side access ports 1301 may be positioned in such a way that they can be accessed through recesses and openings in the side rails 1120, 1130 created by the one or more features described above (e.g. rectangular cut-outs 1121, slots 1122, and pipe cut-outs 1123). The side access ports 1301 may be positioned in such a way as to minimize the opening into the tray 1111 through the side access ports 1301 while the modular shelf 1300 is in the second position, while still allowing for a user to use their hands, fingers, or tools to access the side access ports 1301. For example, in the presently illustrated embodiment, only a half of each side access port 1301 is accessible through the rectangular cut-outs 1121 in the side rails 1120, 1130.

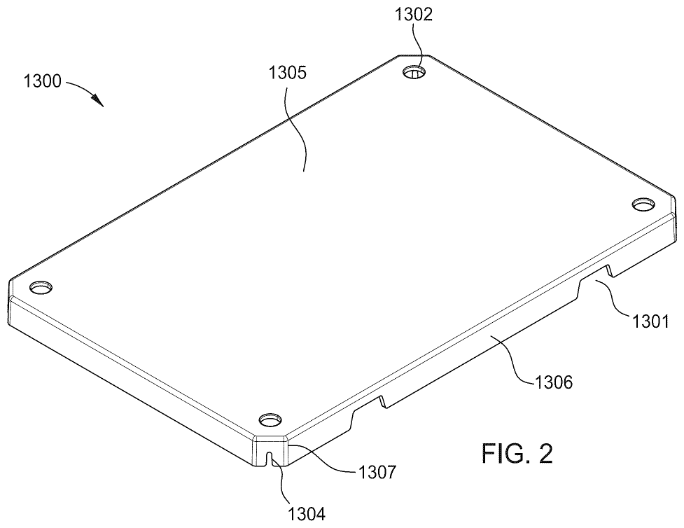

FIG. 2 is a top perspective view of the modular shelf 1300. The modular shelf 1300 includes a top 1305 with finger holes 1302 therethrough, sides 1306 with side access ports 1301 therethrough, and corners 1307 with assembly slots 1304 therethrough.

The modular shelf 1300 is generally rectangular with chamfered corners, however, the modular shelf 1300 may be shaped in any way complementary to the tray 1110 of the top shelf 1100 and in a way that fits between legs 1400. The modular shelf 1300 may have a continuous cross section or may have a hollow underside. In embodiments where the modular shelf 1300 has a hollow underside, the modular shelf 1300 may also have support braces on the underside supporting heavier objects placed atop the modular shelf 1300.

The top 1305 of the modular shelf 1300 is generally flat to allow for both use as a shelf in the first position (as shown in FIG. 1A) and a flat work surface atop the top shelf 1100 in the second position (as shown in FIG. 1B). Alternatively, the top 1305 may have recesses for retaining objects. The top 1305 also includes finger holes 1302. Finger holes 1302 pass through the entirety of the modular shelf 1300 and are used to manipulate the modular shelf 1300. Users may use the finger holes to access underneath the modular shelf 1300 and grab the modular shelf for removal or manipulation when access to other grab-able portions of the shelf 1300 is otherwise limited (such as in the second position of FIG. 1B). In the presently illustrated embodiment, there are four finger holes 1302 disposed on the corners of the top 1305 of the modular shelf 1300. However, in some embodiments, there may be more or less than four finger holes 1302 and they may be placed in various locations of the top 1305 of the modular shelf 1300.

The sides 1306 of the modular shelf 1300 are also generally flat. The sides 1306 include side access ports 1301. As discussed previously, side access ports 1301 may be positioned along the sides 1306 of the modular shelf 1300 so that, in the second position (as shown in FIG. 1B), a user may access and grab the modular shelf 1300 for removal from the second position with their hands and/or tools. The side access ports 1301 are generally rectangular, but may be shaped in any way such that a user may fit their hands, fingers, and/or tools within the side access ports 1301 to grab the modular shelf 1300, access the underneath of the modular shelf 1300 in the second position, and/or access the tray 1110 of the utility cart system 1000 when in the second position. In the presently illustrated embodiment, there are four side access ports 1301 through the sides 1306 of the modular shelf 1300 with two on either side 1306. However, in some embodiments, there may be more or less than four side access ports 1301 and they may be placed at various positions along the sides 1306 based on the features of the rails 1120, 1130 of the utility cart 1000 for access and removal of the modular shelf 1300 in the second position.

The corners 1307 of the modular shelf 1300 each include an assembly slot 1304. Assembly slots 1304 are open to the bottom of the corners 1307 and end before reaching the top of the corner 1307. The assembly slots 1304 are shaped to slide over protrusions and/or fasteners associated with the shelf supports 1303 on the legs 1400 of the utility cart system 1000 so that the modular shelf 1300 can be retained in the first position (as shown in FIG. 1A). The assembly slots 1304 allow for the modular shelf 1300 to be assembled into the first position by placing the modular shelf 1300 down onto the shelf supports 1300 and associated protrusions from above the desired location of the modular shelf 1300. Although an assembly slot 1304 is shown as a connector for coupling with the legs 1400, it is contemplated that other suitable connectors may be used for coupling with the legs 1400, including, but not limited to threaded connections, pin and hole connections, clamps, hooks, and interference fits.

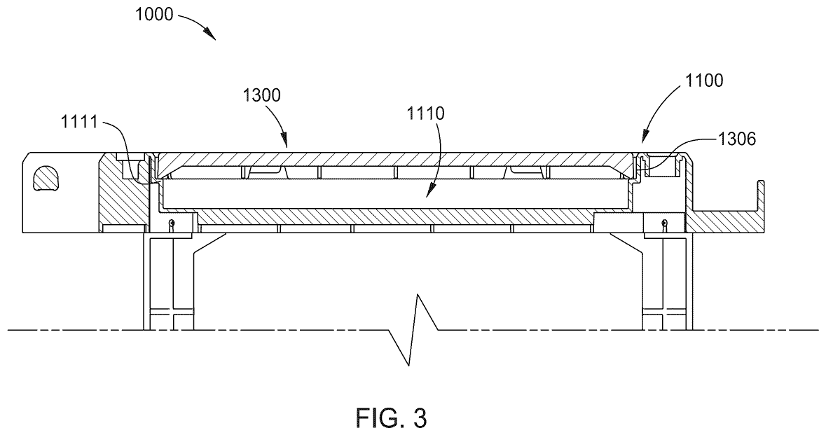

FIG. 3 is a cross-sectional view of the utility cart system 1000 with the modular shelf 1300 in the second position. In the second position, the modular shelf 1300 acts as a lid to the tray 1110 of the top shelf 1100. The sides 1306 of the modular shelf 1300 are supported by the shoulder 1111 of the tray 1110 keeping the modular shelf 1300 raised above the bottom of the tray 1110. In some embodiments, such as the one shown, the sides 1306 of the modular shelf 1300 extend below the bottom surface of the modular shelf 1300 so as to maximize the enclosed space created by the tray 1110 and the modular shelf 1300. In some embodiments, the sides 1306 may extend downward to contact the bottom of the tray 1110. The enclosed space has a desired height to allow for tools and objects to be enclosed within the tray 1110 underneath the modular shelf 1300. In some embodiments, that height may be between 1″ and 6.″

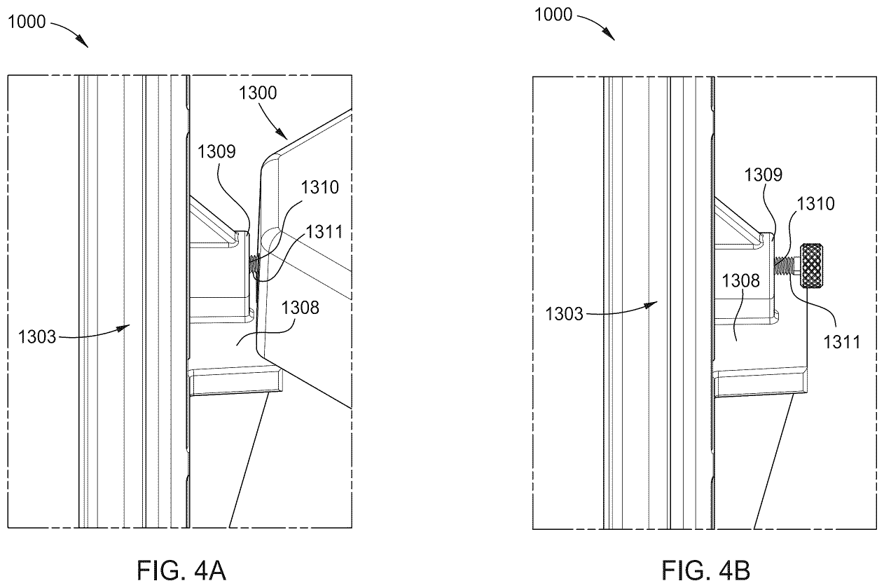

FIG. 4A is a detail view of the shelf support 1303 with the modular shelf 1300 in the first position. As previously discussed, in the first position, the modular shelf 1300 is assembled into the utility cart system 1000 between the top shelf 1100 and the bottom shelf 1200 onto shelf supports 1303 on each of the legs 1400. The shelf supports 1303 include a ledge 1308. In the first position, the corners 1307 of the modular shelf 1300 rest upon, and are supported by the ledge 1308. The shelf supports further include an embossment 1309 that extends inwardly from the legs 1400 and is disposed above the ledge 1308 and bisecting ledge 1308. The embossment 1309 houses a threaded insert 1310. The threaded insert 1310 may be press fit or may be threaded into the embossment 1309. A fastener 1311, such as a thumb screw, is threaded into the insert 1310. The fastener 1311 extends from the insert 1310 and the embossment 1309 and may be adjusted towards the threaded insert 1310 by threading the fastener 1311 in or may be adjusted away from the threaded insert 1310 by unscrewing the fastener 1311 from the threaded insert 1310. In the first position, the shaft of the fastener 1311 engages with the assembly slot 1304. Thus, the modular shelf 1300 is held in the first position by the fasteners 1311 engaging with the assembly slots 1304.

FIG. 4B is a detail view of the shelf support 1303 with the modular shelf 1300 in the second position. In the second position, the modular shelf 1300 is assembled to enclose the tray 1110, leaving the shelf supports 1303 exposed. The fasteners 1311 include a head on their distal ends. When the fasteners 1311 are threaded into the insert 1310 the head moves closer to the insert 1310. In the first position, the fasteners 1311 may be tightened into the inserts 1310 so that the base of the head of the fastener contacts and squeezes an interior surface of the corner 1307 of the modular shelf 1300 to further retain the modular shelf 1300 in the first position.

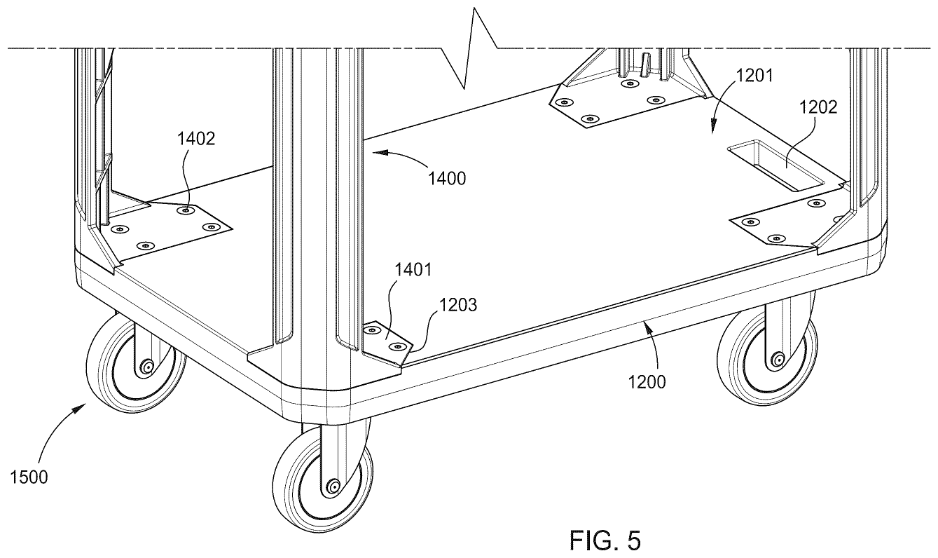

FIG. 5 is a top perspective view of the bottom shelf 1200 of the utility cart system 1000. As stated previously, the bottom shelf 1200 is coupled to the top shelf 1100 by the legs 1400. The legs 1400 are coupled to the bottom shelf 1200 by threaded connection. The legs 1400 are coupled to the corners of the bottom shelf 1200. The shape of the outer portion of the legs 1400 is the same as the corners of the bottom shelf 1200 so that the outer edge of the bottom shelf 1200 is a continuous shape.

The bottom shelf 1200 is generally rectangular with chamfered corners, however, the bottom shelf 1200 may be shaped in any way complementary to the overall shape of the utility cart system 1000. The bottom shelf 1200 may have a continuous cross section or may have a hollow underside. In embodiments where the bottom shelf 1200 has a hollow underside, the bottom shelf 1200 may also have support braces on the underside supporting heavier objects placed atop the bottom shelf 1200.

The top 1201 of the bottom shelf 1200 is generally flat to allow for objects to sit atop of. Alternatively, the top 1201 may have recesses for retaining objects. The top 1201 includes a vertical material holder recess 1202. The recess 1202 is generally rectangular and terminates before passing through the entirety of the bottom shelf 1200. As discussed previously, raw materials may be stored vertically on the utility cart system 1000 by passing through vertical material holder 1151. Said raw materials pass through the vertical material holder 1151 and the bottom ends rest and are supported in the recess 1202 to keep the materials from moving, falling over, and/or falling off the bottom shelf 1200. As such, the recess 1202 is positioned on the bottom shelf 1202 underneath the vertical material holder 1151 so that the raw materials contained therein are retained on the utility cart system 1000 vertically.

The top 1201 of the bottom shelf 1200 also includes leg recesses 1203. Leg recesses 1203 are located on the corners of the top 1201 of the bottom shelf 1200. Leg recesses 1203 also extend off of the sides of the bottom shelf 1200. Leg recesses 1203 are shaped complementary to attachment flanges 1401 of the legs 1400 so that the attachment flanges 1401 of the legs 1400 fit into the leg recesses 1203. The leg recesses 1203 are as deep as the attachment flanges 1401 are tall, so that there is no change in height from the top 1201 of the bottom shelf 1200 to the top of the attachment flange 1401 and the entirety of the top surface of the bottom shelf 1200 is level aside from the recess 1202. The attachment flanges 1401 are fit into the leg recesses 1203 and coupled to the bottom shelf 1200 by fasteners 1402. The fasteners 1402 are countersunk screws, so that the top surface 1201 of the bottom shelf 1200 is level and there is no height change between the top 1201 of the bottom shelf, the attachment flanges 1401, and the fasteners 1402.

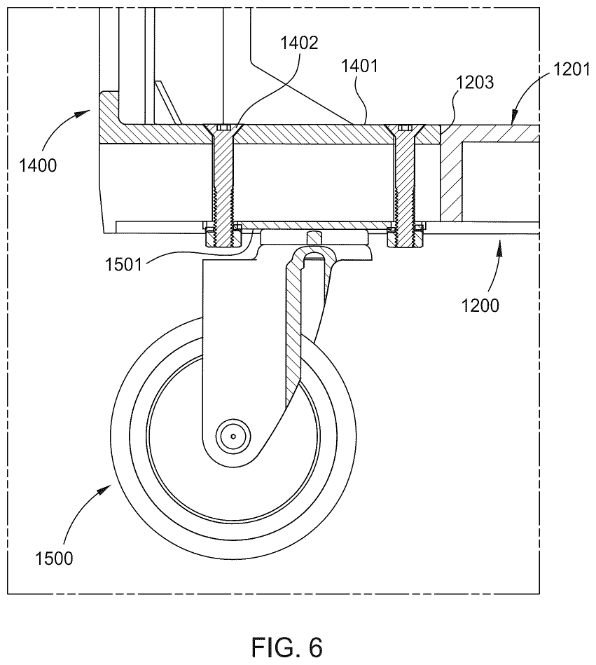

FIG. 6 is a detail view of a cross-sectional view of the bottom shelf 1200, legs 1400, and casters 1500 of the utility cart system 1000.

As stated previously, the legs 1400 are assembled onto the bottom shelf 1200 by fasteners 1402 passing through both the attachment flanges 1401 and the bottom shelf 1200 and the attachment flanges 1401 rest in leg recesses 1203. The casters 1500 are located underneath the attachment flanges 1401 of the legs 1400 and the bottom shelf 1200. The same fasteners 1402 that secure the legs 1400 to the bottom shelf 1200 also secure the casters 1500 to the utility cart system 1000. Thus, the fasteners 1402, such as the countersink screws, pass through the attachment flanges 1401 secured in the leg recess 1203 of the bottom shelf 1200, pass through holes in the bottom shelf 1200, pass through mounting plates 1501 of the casters 1500, and are secured by nuts on the other side of the mounting plates 1501.

It is contemplated that one or more of these aspects disclosed herein may be combined. Moreover, it is contemplated that one or more of these aspects may include some or all of the aforementioned benefits.

As an example, the present disclosure contemplates that one or more of the aspects, features, components, operations, and/or properties of the system 1000 may be combined.

In some embodiments, a utility cart system includes a top shelf with a recessed tray and a bottom shelf disposed below the top shelf. A plurality of shelf supports are used to couple the top shelf to the bottom shelf. A plurality of casters are coupled to a bottom of the bottom shelf. A modular shelf is movable between a first position and a second position. In the first position, the modular shelf is disposed between the top shelf and the bottom shelf and coupled to the plurality of shelf supports. In the second position, the modular shelf is at least partially disposed in the recessed tray of the top shelf.

In some embodiments, a utility cart system includes a top shelf comprising a recessed tray having a shoulder above a bottom of the recessed tray. The system also includes a bottom shelf disposed below the top shelf and coupled to the top shelf by a plurality of legs. A plurality of casters are coupled to a bottom of the bottom shelf and coupled to the plurality of legs. Each leg of the plurality of legs is coupled to each caster of the plurality of casters by a fastener passing through the bottom shelf. The system further includes a modular shelf having a size that is at least partially disposable in the recessed tray and a connector for coupling with the plurality of legs.

In some embodiments, a utility cart system includes a top shelf comprising a recessed tray having a shoulder above a bottom of the recessed tray and a bottom shelf disposed below the top shelf. The system also includes a plurality of casters coupled to the bottom shelf. A modular shelf is disposable between a first position and a second position. In the first position, the modular shelf is disposed between the top shelf and the bottom shelf on a plurality of shelf supports, wherein each shelf support of the plurality of shelf supports comprise a support surface. In the second position, the modular shelf is disposed on the shoulder of the top shelf and the modular shelf encloses the recessed tray.

In some embodiments, when in the second position, the modular shelf encloses the recessed tray.

In some embodiments, the recessed tray comprises a shoulder above a bottom of the recessed tray and in the second position, the modular shelf is disposed on the shoulder.

In some embodiments, when in the second position, the modular shelf is substantially flush with a top of the top shelf.

In some embodiments, each of the plurality of the shelf supports includes a support surface disposed below an embossment, wherein the embossment comprises a threaded insert. The plurality of the shelf supports also includes a fastener is disposed in the threaded insert, and the fastener protrudes from the embossment.

In some embodiments, the plurality of the shelf the modular shelf comprises a plurality of corner surfaces, wherein each corner surface comprises a slot.

In some embodiments, when in the first position, the plurality of corner surfaces of the modular shelf are disposed on the support surfaces of the plurality of the shelf supports and the fasteners of the plurality of the shelf supports are disposed in the slots of the plurality of corner surfaces.

In some embodiments, the top shelf comprises a plurality of recesses and the plurality of recesses comprise a cup holder.

In some embodiments, the system also includes a hook, wherein the hook having an axial protrusion extending from the top shelf; and a vertical protrusion extending from a distal end of the axial protrusion.

In some embodiments, the top shelf further comprises a first side rail and a second side rail, wherein the first side rail and the second side rail comprise a plurality of cut-outs extending through the first side rail and the second side rail. The plurality of cut-outs includes a rectangular cut-out; a v-shaped cut-out; and a plurality of slots.

In some embodiments, the modular shelf includes at least one finger hole disposed on a top surface of the modular shelf; and at least one access hole disposed on a side of the modular shelf.

In some embodiments, when in the second position, the at least one access hole of the modular shelf is aligned with a cut-out of a side rail of the top shelf.

In some embodiments, the modular shelf comprises a plurality of corner surfaces, wherein each corner surface comprises the connector and wherein the connector is a slot.

In some embodiments, when in the first position, the plurality of corner surfaces of the modular shelf are disposed on the support surfaces of the plurality of the shelf supports and the fasteners of the plurality of the shelf supports are disposed in the slots of the plurality of corner surfaces.

In some embodiments, the modular shelf includes at least one finger hole disposed on a top surface of the modular shelf; and at least one access hole disposed on a side of the modular shelf.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the embodiments described herein may be substituted in for one or more of the other aspects described. The scope of the disclosure is determined by the claims that follow.

What is claimed is:

1. A utility cart system, comprising:
a top shelf comprising a recessed tray;
a bottom shelf disposed below the top shelf;
a plurality of shelf supports coupling the top shelf to the bottom shelf;
a plurality of casters coupled to a bottom of the bottom shelf; and
a modular shelf movable between a first position and a second position, wherein:
in the first position, the modular shelf is disposed between the top shelf and the bottom shelf and coupled to the plurality of shelf supports; and
in the second position, the modular shelf is at least partially disposed in the recessed tray of the top shelf.

2. The utility cart system of claim 1, wherein in the second position, the modular shelf encloses the recessed tray.

3. The utility cart system of claim 1, wherein the recessed tray comprises a shoulder above a bottom of the recessed tray and in the second position, the modular shelf is disposed on the shoulder.

4. The utility cart system of claim 1, wherein in the second position, the modular shelf is substantially flush with a top of the top shelf.

5. The utility cart system of claim 1, wherein each of the plurality of the shelf supports comprises:
a support surface disposed below an embossment, wherein the embossment comprises a threaded insert, a fastener is disposed in the threaded insert, and the fastener protrudes from the embossment.

6. The utility cart system of claim 5, wherein the modular shelf comprises a plurality of corner surfaces, wherein each corner surface comprises a slot.

7. The utility cart system of claim 6, wherein in the first position, the plurality of corner surfaces of the modular shelf are disposed on the support surfaces of the plurality of the shelf supports and the fasteners of the plurality of the shelf supports are disposed in the slots of the plurality of corner surfaces.

8. The utility cart system of claim 1, wherein the top shelf comprises a plurality of recesses and the plurality of recesses comprise a cup holder.

9. The utility cart system of claim 1 further comprising a hook, wherein the hook comprises:
an axial protrusion extending from the top shelf; and
a vertical protrusion extending from a distal end of the axial protrusion.

10. The utility cart system of claim 1, wherein the top shelf further comprises a first side rail and a second side rail, wherein the first side rail and the second side rail comprise a plurality of cut-outs extending through the first side rail and the second side rail, and wherein the plurality of cut-outs comprise:
a rectangular cut-out;
a v-shaped cut-out; and
a plurality of slots.

11. The utility cart system of claim 1, wherein the modular shelf comprises:
at least one finger hole disposed on a top surface of the modular shelf; and
at least one access hole disposed on a side of the modular shelf.

12. A utility cart system, comprising:
a top shelf comprising a recessed tray, wherein the recessed tray comprises a shoulder above a bottom of the recessed tray;
a bottom shelf disposed below the top shelf and coupled to the top shelf by a plurality of legs;
a plurality of casters coupled to a bottom of the bottom shelf and coupled to the plurality of legs, wherein each leg of the plurality of legs is coupled to each caster of the plurality of casters by a fastener passing through the bottom shelf; and
a modular shelf having a size that is at least partially disposable in the recessed tray and a connector for coupling with the plurality of legs.

13. The utility cart system of claim 12, wherein the connector comprises a slot.

14. The utility cart system of claim 12, wherein:
a top surface of the bottom shelf comprises a plurality of recesses; and
each leg of the plurality of legs comprises a bottom flange and the bottom flanges are disposed in the plurality of recesses of the bottom shelf.

15. The utility cart system of claim 12, wherein the plurality of casters comprise at least one swivel caster and at least one fixed caster.

16. The utility cart system of claim 12, wherein the modular shelf is disposable between:
a first position between the top shelf and the bottom shelf on a plurality of shelf supports; and
a second position on the shoulder of the top shelf and the modular shelf encloses the recessed tray.

17. The utility cart system of claim 16, wherein each shelf support of the plurality of shelf supports comprises:
a support surface disposed below an embossment, wherein the embossment comprises a threaded insert, a fastener is disposed in the threaded insert, and the fastener protrudes from the embossment.

18. A utility cart system, comprising:
a top shelf comprising a recessed tray, wherein the recessed tray comprises a shoulder above a bottom of the recessed tray;
a bottom shelf disposed below the top shelf;
a plurality of casters coupled to the bottom shelf; and
a modular shelf disposable between a first position and a second position, wherein:
in the first position, the modular shelf is disposed between the top shelf and the bottom shelf on a plurality of shelf supports, wherein each shelf support of the plurality of shelf supports comprise a support surface; and
in the second position, the modular shelf is disposed on the shoulder of the top shelf and the modular shelf encloses the recessed tray.

19. The utility cart system of claim 18, wherein:
the modular shelf comprises a plurality of corner surfaces; and
in the first position, the plurality of corner surfaces of the modular shelf are disposed on the support surfaces of the plurality of the shelf supports.

20. The utility cart system of claim 19, wherein:
each shelf support of the plurality of shelf supports further comprise a fastener protruding from the shelf support;
each corner surface of the plurality of corner surfaces comprises a slot; and
in the first position, the fasteners of the plurality of the shelf supports are disposed in the slots of the plurality of corner surfaces.
